(19) United States
(12) Patent Application Publication
(10) Pub. No.: US 2025/0240714 A1
(43) Pub. Date: Jul. 24, 2025

(54) Handling Ecall Timers When Unavailability Period, Mobile-Initiated-Connection-Only Or Power Saving Mode Is Activated In Mobile Communications

(71) Applicant: MediaTek Singapore Pte. Ltd., Singapore (SG)

(72) Inventors: Marko Niemi, Oulu (FI); Puneet Puneet, Bengaluru KA (IN); Yu-Hsin Lin, Hsinchu City (TW)

(21) Appl. No.: 19/034,447

(22) Filed: Jan. 22, 2025

(30) Foreign Application Priority Data
Jan. 24, 2024 (IN) 202421004963

(51) Int. Cl. H04W 52/02; H04W 76/28

(52) U.S. Cl. CPC H04W 52/0216; H04W 52/0261; H04W 76/28

(57) ABSTRACT

Techniques pertaining to handling eCall timers when an unavailability period is activated in mobile communications are described. An apparatus (e.g., a user equipment (UE) determines an occurrence of one or more conditions related to an unavailability period, mobile-initiated-connection-only or power saving mode such as, for example, the unavailability period being activated. In response to the determining, the apparatus performs one or more actions such as, for example, keeping one or more eCall related timers running and/or performing an eCall inactivity procedure.

### CROSS REFERENCE TO RELATED PATENT APPLICATION(S)

The present disclosure claims the priority benefit of Indian Patent Application number 202421004963, filed 24 Jan. 2024, the content of which herein being incorporated by reference in its entirety.

### TECHNICAL FIELD

The present disclosure is generally related to mobile communications and, more particularly, to handling eCall timers when an unavailability period, mobile-initiated-connection-only or power saving mode is activated in mobile communications.

### BACKGROUND

In wireless communications such as mobile communications under the current 3rd Generation Partnership Project (3GPP) specification, eCall is a system used in vehicles designed to automatically make an emergency call if/when a vehicle is involved in a serious road accident. An eCall inactivity procedure is performed only in 3GPP access and applicable only to a user equipment (UE) configured for eCall only mode as specified in 3GPP Technical Specification (TS) 31.102. The procedure is to be started when: (a) the UE is in any 5GMM-REGISTERED substrate except substrates 5GMM-REGISTERED.PLMN-SEARCH or 5GMM-REGISTERED.NO-CELL-AVAILABLE; (b) the UE is in 5GMM-IDLE mode or 5GMM-CONNECTED mode with radio resource control (RRC) inactive indication; and (c) one of the following conditions applies: (1) timer T3444 expires or is found to have already expired and timer T3445 is not running; (2) timer T3445 expires or is found to have already expired and timer T3444 is not running; or (3) timers T3444 and T3445 expire or are found to have already expired. The UE is then to perform the following actions: (a) stop other running timers (e.g., T3511, T3512); (b) if the UE is currently registered to the network for 5th Generation System (5GS) services, perform a de-registration procedure; (c) delete any 5th Generation Global Unique Temporary Identifier (5G-GUTI), tracking area identifier (TAI) list, last visited registered TAI, list of equivalent public land mobile networks (PLMNs), and ngKSI; and (d) enter the 5GMM-DEREGISTERED.eCALL-INACTIVE state. When the unavailability period, mobile-initiated-connection-only or power saving mode is activated, all non-access stratum (NAS) timers are stopped and associated procedures aborted except for timers T3512, T3346, T3447, T3448, T3396, T3584, T3585, any back-off timers, T3245, T3247, the timer T controlling the periodic search for home PLMN (HPLMN) or equivalent HPLMN (EHPLMN) or higher prioritized PLMNs, and the timer TSENSE controlling the periodic search for PLMNs satisfying the operator controlled signal level threshold.

However, when an unavailability period, mobile-initiated-connection-only or power saving mode is activated, then UE is to stop the eCall timers T3444 and T3445. When one or more of the timers (e.g., T3444 and T3445) are running and is/are stopped due to the unavailability period, the UE would never enter to the eCall mode after resuming of normal service in the UE. Therefore, there is a need for a solution of handling eCall timers when an unavailability period, mobile-initiated-connection-only or power saving mode is activated in mobile communications.

### SUMMARY

The following summary is illustrative only and is not intended to be limiting in any way. That is, the following summary is provided to introduce concepts, highlights, benefits, and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the issue(s) described herein. More specifically, various schemes proposed in the present disclosure are believed to provide solutions pertaining to handling eCall timers when an unavailability period, mobile-initiated-connection-only or power saving mode is activated in mobile communications. It is believed that implementations of one or more of the schemes proposed herein may address or otherwise alleviate the issues described above.

In one aspect, a method may involve a UE determining an occurrence of one or more conditions related to an unavailability period, mobile-initiated-connection-only or power saving mode. The method may also involve the UE performing one or more actions responsive to the determining.

In another aspect, a method may involve a UE determining an occurrence of one or more conditions other than an unavailability period. The method may also involve the UE performing an action responsive to the determining.

It is noteworthy that, although the description provided herein may be in the context of certain radio access technologies, networks, and network topologies such as 5^{th} Generation (5G)/New Radio (NR)/Beyond Fifth-Generation (B5G) mobile communications, the proposed concepts, schemes and any variation(s)/derivative(s) thereof may be implemented in, for and by other types of radio access technologies, networks and network topologies such as, for example and without limitation, 4^{th} Generation (4G)/Long-Term Evolution (LTE), LTE-Advanced, LTE-Advanced Pro, Internet-of-Things (IoT), Narrow Band Internet of Things (NB-IoT), Industrial Internet of Things (IIoT), vehicle-to-everything (V2X), and non-terrestrial network (NTN) communications. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example network environment in which various solutions and schemes in accordance with the present disclosure may be implemented.

FIG. 2 is a block diagram of an example communication system under a proposed scheme in accordance with the present disclosure.

FIG. 3 is a flowchart of a second example process under a proposed scheme in accordance with the present disclosure.

FIG. 4 is a flowchart of a second example process under a proposed scheme in accordance with the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to handling eCall timers when an unavailability period, mobile-initiated-connection-only or power saving mode is activated in mobile communications. According to the present disclosure, a number of possible solutions may be implemented separately or jointly. That is, although these possible solutions may be described below separately, two or more of these possible solutions may be implemented in one combination or another.

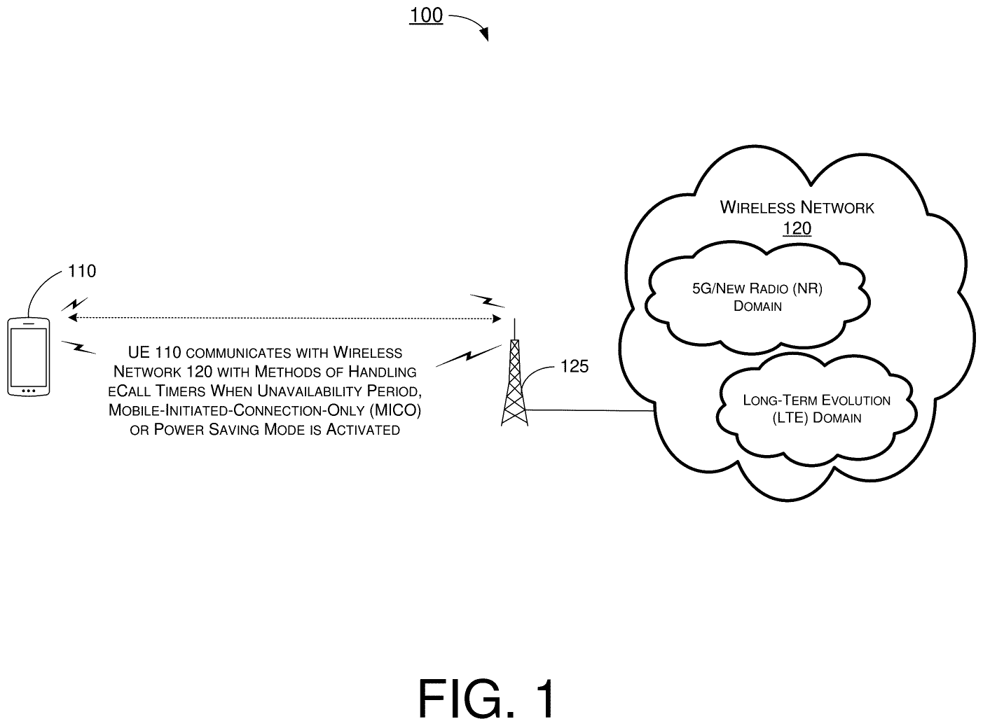

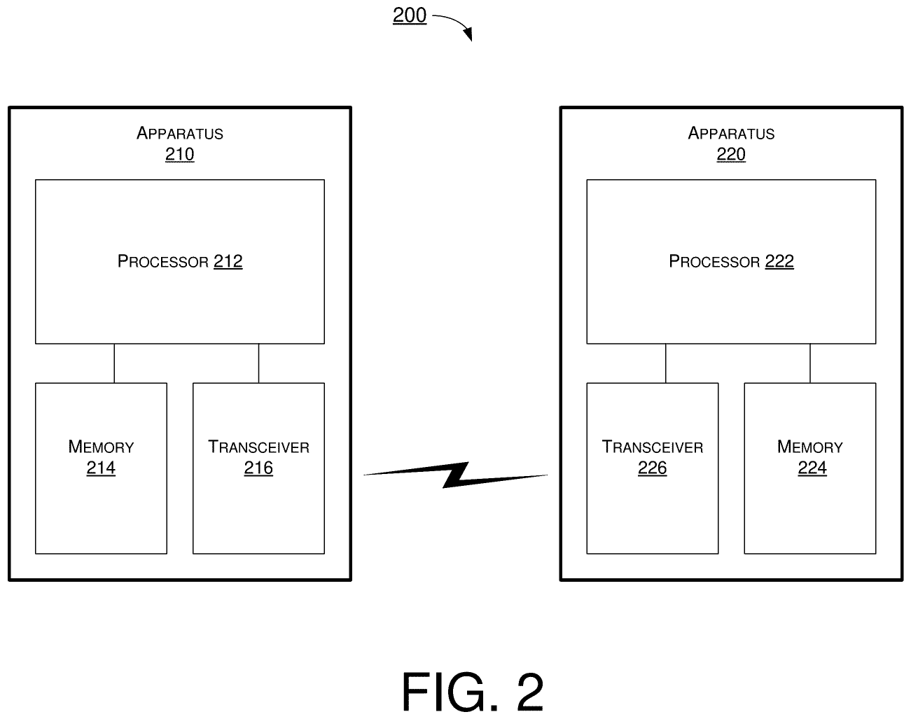

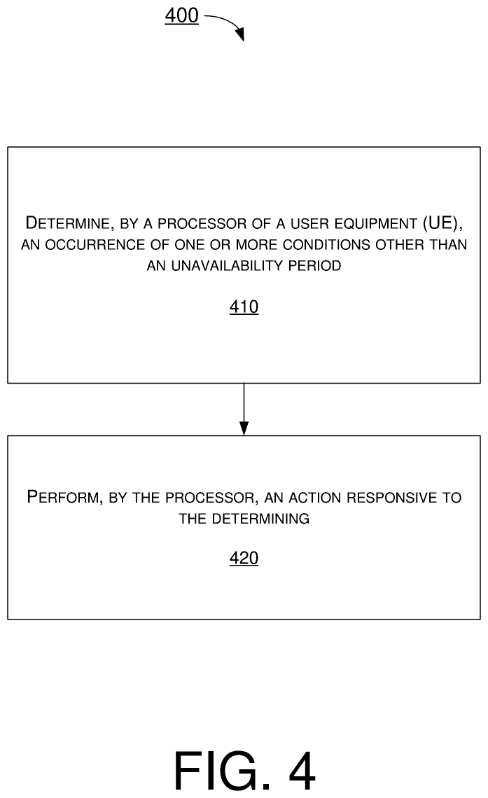

FIG. 1 illustrates an example network environment 100 in which various solutions and schemes in accordance with the present disclosure may be implemented. FIG. 2˜FIG. 4 illustrate examples of implementation of various proposed schemes in network environment 100 in accordance with the present disclosure. The following description of various proposed schemes is provided with reference to FIG. 1˜FIG. 4.

Referring to FIG. 1, network environment 100 may involve a UE 110, such as a mobile device or smartphone, in wireless communication with a wireless network 120 as part of a communication network. The wireless network 120 may be one or more PLMNs including 5G/NR domain, 4G/LTE domain, and 2G/3G domain. UE 110 may initially be in wireless communication with wireless network 120 via a base station or network node 125 (e.g., an eNB, gNB or transmit-receive point (TRP)). In network environment 100, UE 110 and the wireless network 120 may implement various schemes pertaining to handling eCall timers when an unavailability period, mobile-initiated-connection-only or power saving mode is activated in mobile communications in accordance with the present disclosure, as described herein.

It is noteworthy that, while the various proposed schemes may be individually or separately described below, in actual implementations some or all of the proposed schemes may be utilized or otherwise implemented jointly. Of course, each of the proposed schemes may be utilized or otherwise implemented individually or separately. Moreover, as used herein, a lower layer may refer to a layer in the 5GMM protocol stack that is lower than the radio resource control (RRC) layer, such as a packet data convergence protocol (PDCP) layer, a radio control link (RLC) layer, a medium access control (MAC) layer, a physical (PHY) layer, or so forth.

Under a proposed scheme in accordance with the present disclosure, upon occurrence of one or more conditions, UE 110 may perform one or more actions. For instance, the one or more conditions may include one or more of the following: (1) UE 110 activating an unavailability period duration; (2) the unavailability period being activated for a discontinuous coverage; (3) the unavailability period being activated for other reasons (e.g., as defined in 3GPP TS 24.501 subclause 5.3.26); (4) an access stratum being deactivated for a 3GPP access; (5) the unavailability period being activated; (6) the access stratum being deactivated for the discontinuous coverage; (7) the access stratum being deactivated other reasons (e.g., as defined in 3GPP TS 24.501 subclause 5.3.26); (8) a mobile-initiated-connection-only (MICO) mode being activated; (9) a power-saving mode (PSM) being activated; and/or (10) one or more eCall related timers (e.g., T3444, T3445, T3242, T3243 and the like) being stopped. Under the proposed scheme, in response to occurrence of one or more of aforementioned conditions, UE 110 may reset one or more counters. For instance, UE 110 may keep running (e.g., not stop) the eCall related timers, such as T3444, T3445, T3242 and T3243. Alternatively, or additionally, UE 110 may perform an eCall inactivity procedure.

As an implementational example, when the unavailability period, mobile-initiated-connection-only or power saving mode is activated, all NAS timers may be stopped and associated procedures may be aborted, except for the following: timers T3512, T3346, T3447, T3448, T3396, T3584, T3585, any back-off timers, T3245, T3247, T3444, T3445 the timer T controlling the periodic search for HPLMN or EHPLMN or higher prioritized PLMNs, and the timer TSENSE controlling the periodic search for PLMNs satisfying the operator controlled signal level threshold (e.g., as specified in 3GPP TS 23.122).

### Illustrative Implementations

FIG. 2 illustrates an example communication system 200 having at least an example apparatus 210 and an example apparatus 220 in accordance with an implementation of the present disclosure. Each of apparatus 210 and apparatus 220 may perform various functions to implement schemes, techniques, processes and methods described herein pertaining to handling eCall timers when an unavailability period, mobile-initiated-connection-only or power saving mode is activated in mobile communications, including the various schemes described above with respect to various proposed designs, concepts, schemes, systems and methods described above, including network environment 100, as well as processes described below.

Each of apparatus 210 and apparatus 220 may be a part of an electronic apparatus, which may be a network apparatus or a UE (e.g., UE 110), such as a portable or mobile apparatus, a wearable apparatus, a vehicular device or a vehicle, a wireless communication apparatus or a computing apparatus. For instance, each of apparatus 210 and apparatus 220 may be implemented in a smartphone, a smart watch, a personal digital assistant, an electronic control unit (ECU) in a vehicle, a digital camera, or a computing equipment such as a tablet computer, a laptop computer or a notebook computer. Each of apparatus 210 and apparatus 220 may also be a part of a machine type apparatus, which may be an IoT apparatus such as an immobile or a stationary apparatus, a home apparatus, a roadside unit (RSU), a wire communication apparatus or a computing apparatus. For instance, each of apparatus 210 and apparatus 220 may be implemented in a smart thermostat, a smart fridge, a smart door lock, a wireless speaker or a home control center. When implemented in or as a network apparatus, apparatus 210 and/or apparatus 220 may be implemented in an eNodeB in an LTE, LTE-Advanced or LTE-Advanced Pro network or in a gNB or TRP in a 5G network, an NR network, or an IoT network.

In some implementations, each of apparatus 210 and apparatus 220 may be implemented in the form of one or more integrated-circuit (IC) chips such as, for example and without limitation, one or more single-core processors, one or more multi-core processors, one or more complex-instruction-set-computing (CISC) processors, or one or more reduced-instruction-set-computing (RISC) processors. In the various schemes described above, each of apparatus 210 and apparatus 220 may be implemented in or as a network apparatus or a UE. Each of apparatus 210 and apparatus 220 may include at least some of those components shown in FIG. 2 such as a processor 212 and a processor 222, respectively, for example. Each of apparatus 210 and apparatus 220 may further include one or more other components not pertinent to the proposed scheme of the present disclosure (e.g., internal power supply, display device and/or user interface device), and, thus, such component(s) of apparatus 210 and apparatus 220 are neither shown in FIG. 2 nor described below in the interest of simplicity and brevity.

In one aspect, each of processor 212 and processor 222 may be implemented in the form of one or more single-core processors, one or more multi-core processors, or one or more CISC or RISC processors. That is, even though a singular term “a processor” is used herein to refer to processor 212 and processor 222, each of processor 212 and processor 222 may include multiple processors in some implementations and a single processor in other implementations in accordance with the present disclosure. In another aspect, each of processor 212 and processor 222 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 212 and processor 222 is a special-purpose machine specifically designed, arranged, and configured to perform specific tasks including those pertaining to handling eCall timers when an unavailability period, mobile-initiated-connection-only or power saving mode is activated in mobile communications in accordance with various implementations of the present disclosure.

In some implementations, apparatus 210 may also include a transceiver 216 coupled to processor 212. Transceiver 216 may be capable of wirelessly transmitting and receiving data. In some implementations, transceiver 216 may be capable of wirelessly communicating with different types of wireless networks of different radio access technologies (RATs). In some implementations, transceiver 216 may be equipped with a plurality of antenna ports (not shown) such as, for example, four antenna ports. That is, transceiver 216 may be equipped with multiple transmit antennas and multiple receive antennas for multiple-input multiple-output (MIMO) wireless communications. In some implementations, apparatus 220 may also include a transceiver 226 coupled to processor 222. Transceiver 226 may include a transceiver capable of wirelessly transmitting and receiving data. In some implementations, transceiver 226 may be capable of wirelessly communicating with different types of UEs/wireless networks of different RATs. In some implementations, transceiver 226 may be equipped with a plurality of antenna ports (not shown) such as, for example, four antenna ports. That is, transceiver 226 may be equipped with multiple transmit antennas and multiple receive antennas for MIMO wireless communications.

In some implementations, apparatus 210 may further include a memory 214 coupled to processor 212 and capable of being accessed by processor 212 and storing data therein. In some implementations, apparatus 220 may further include a memory 224 coupled to processor 222 and capable of being accessed by processor 222 and storing data therein. Each of memory 214 and memory 224 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 214 and memory 224 may include a type of read-only memory (ROM) such as mask ROM, programmable ROM (PROM), erasable programmable ROM (EPROM) and/or electrically erasable programmable ROM (EEPROM). Alternatively, or additionally, each of memory 214 and memory 224 may include a type of non-volatile random-access memory (NVRAM) such as flash memory, solid-state memory, ferroelectric RAM (FeRAM), magnetoresistive RAM (MRAM) and/or phase-change memory.

Each of apparatus 210 and apparatus 220 may be a communication entity capable of communicating with each other using various proposed schemes in accordance with the present disclosure. For illustrative purposes and without limitation, a description of capabilities of apparatus 210, as a UE (e.g., UE 110), and apparatus 220, as a network node (e.g., network node 125) of a network (e.g., wireless network 120 as a 5G/NR mobile network), is provided below in the context of example process es 300 and 400.

### Illustrative Processes

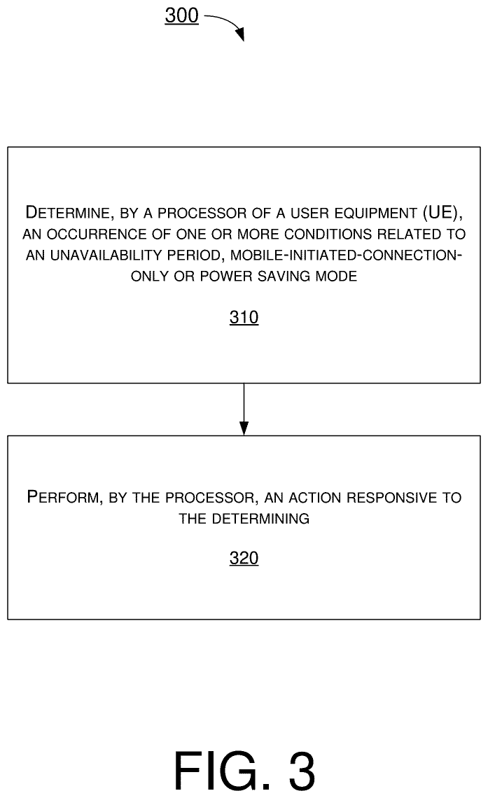

FIG. 3 illustrates an example process 300 in accordance with an implementation of the present disclosure. Process 300 may represent an aspect of implementing various proposed designs, concepts, schemes, systems and methods described above. More specifically, process 300 may represent an aspect of the proposed concepts and schemes pertaining to handling eCall timers when an unavailability period, mobile-initiated-connection-only or power saving mode is activated in mobile communications in accordance with the present disclosure. Process 300 may include one or more operations, actions, or functions as illustrated by one or more of blocks 310 and 320. Although illustrated as discrete blocks, various blocks of process 300 may be divided into additional blocks, combined into fewer blocks, or eliminated, depending on the desired implementation. Moreover, the blocks/sub-blocks of process 300 may be executed in the order shown in FIG. 3 or, alternatively, in a different order. Furthermore, one or more of the blocks/sub-blocks of process 300 may be executed repeatedly or iteratively. Process 300 may be implemented by or in apparatus 210 and apparatus 220 as well as any variations thereof. Solely for illustrative purposes and without limiting the scope, process 300 is described below in the context of apparatus 210 as a UE (e.g., UE 110) and apparatus 220 as a communication entity such as a network node or base station (e.g., network node 125) of a network (e.g., wireless network 120). Process 300 may begin at block 310.

At 310, process 300 may involve processor 212 of apparatus 210 determining an occurrence of one or more conditions related to an unavailability period, mobile-initiated-connection-only or power saving mode. Process 300 may proceed from 310 to 320.

At 320, process 300 may involve processor 212 performing one or more actions responsive to the determining.

In some implementations, the one or more actions may include one or more of the following: (a) determining one or more eCall related timers running; (b) determining the occurrence of the one or more conditions; (c) keeping one or more eCall related timers running; and (d) performing an eCall inactivity procedure at an expiry of at least one of the one or more eCall related timers.

In some implementations, the one or more conditions may include one or more eCall related timers are running. Alternatively, or additionally, one of the one or more conditions may include apparatus 210 activating the unavailability period.

In some implementations, the one or more actions may involve keeping one or more eCall related timers running. In some implementations, the one or more eCall related timers may include one or more of timers T3444, T3445, T3242 and T3243.

In some implementations, one of the one or more conditions may include the unavailability period being activated for a discontinuous coverage. Alternatively, or additionally, one of the one or more conditions may include the unavailability period being activated for one or more UE reasons other than a discontinuous coverage. Such one or more UE reasons may include, for example, silent modem reset, security patch updates, operating system (OS) upgrades, modem software updates, and/or device reboot modem setting changes via Open Mobile Alliance Device Management (OMA-DM).

FIG. 4 illustrates an example process 400 in accordance with an implementation of the present disclosure. Process 400 may represent an aspect of implementing various proposed designs, concepts, schemes, systems and methods described above. More specifically, process 400 may represent an aspect of the proposed concepts and schemes pertaining to handling eCall timers when an unavailability period, mobile-initiated-connection-only or power saving mode is activated in mobile communications in accordance with the present disclosure. Process 400 may include one or more operations, actions, or functions as illustrated by one or more of blocks 410 and 420. Although illustrated as discrete blocks, various blocks of process 400 may be divided into additional blocks, combined into fewer blocks, or eliminated, depending on the desired implementation. Moreover, the blocks/sub-blocks of process 400 may be executed in the order shown in FIG. 4 or, alternatively, in a different order. Furthermore, one or more of the blocks/sub-blocks of process 400 may be executed repeatedly or iteratively. Process 400 may be implemented by or in apparatus 210 and apparatus 220 as well as any variations thereof. Solely for illustrative purposes and without limiting the scope, process 400 is described below in the context of apparatus 210 as a UE (e.g., UE 110) and apparatus 220 as a communication entity such as a network node or base station (e.g., network node 125) of a network (e.g., wireless network 120). Process 400 may begin at block 410.

At 410, process 400 may involve processor 212 of apparatus 210 determining an occurrence of one or more conditions other than an unavailability period. Process 400 may proceed from 410 to 420.

At 420, process 400 may involve processor 212 performing an action responsive to the determining.

In some implementations, the action may involve keeping one or more eCall related timers running. In some implementations, the one or more eCall related timers may include one or more of timers T3444, T3445, T3242 and T3243.

In some implementations, the one or more conditions may include a MICO mode being activated. Alternatively, or additionally, the one or more conditions may include a PSM being activated. Alternatively, or additionally, the one or more conditions may include one or more eCall related timers being running. In some implementations, the one or more eCall related timers may include one or more of timers T3444, T3445, T3242 and T3243.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
determining, by a processor of a user equipment (UE), an occurrence of one or more conditions related to an unavailability period, mobile-initiated-connection-only or power saving mode; and
performing, by the processor, one or more actions responsive to the determining.

2. The method of claim 1, wherein the one or more conditions comprises one or more eCall related timers are running.

3. The method of claim 1, wherein one of the one or more conditions comprises the UE activating the unavailability period.

4. The method of claim 1, wherein the one or more actions comprises keeping one or more eCall related timers running.

5. The method of claim 4, wherein the one or more eCall related timers comprise one or more of timers T3444, T3445, T3242 and T3243. The method of claim 1, wherein one of the one or more conditions comprises the unavailability period being activated for a discontinuous coverage.

6. The method of claim 1, wherein one of the one or more conditions comprises the unavailability period being activated for one or more UE reasons other than a discontinuous coverage.

7. A method, comprising:
determining, by a processor of a user equipment (UE), an occurrence of a one or more conditions other than an unavailability period; and
performing, by the processor, an action responsive to the determining.

8. The method of claim 7, wherein the action comprises keeping one or more eCall related timers running.

9. The method of claim 8, wherein the one or more eCall related timers comprise one or more of timers T3444, T3445, T3242 and T3243.

10. The method of claim 7, wherein the one or more conditions comprises a mobile-initiated-connection-only (MICO) mode being activated.

11. The method of claim 7, wherein the one or more conditions comprises a power-saving mode (PSM) being activated.

12. The method of claim 7, wherein the one or more conditions comprises one or more eCall related timers being running.

13. The method of claim 12, wherein the one or more eCall related timers comprise one or more of timers T3444, T3445, T3242 and T3243.

14. An apparatus implementable in a user equipment (UE), comprising:
a transceiver configured to communicate wirelessly; and
a processor coupled to the transceiver and configured to perform operations comprising:
determining an occurrence of a one or more conditions related to an unavailability period, mobile-initiated-connection-only or power saving mode; and
performing one or more actions responsive to the determining.

15. The apparatus of claim 14, wherein the one or more actions comprises one or more of:
determining one or more eCall related timers running;
determining the occurrence of the one or more conditions;
keeping one or more eCall related timers running; and
performing an eCall inactivity procedure at an expiry of at least one of the one or more eCall related timers.
